(19) United States
(12) Patent Application Publication
(10) Pub. No.: US 2022/0341206 A1
(43) Pub. Date: Oct. 27, 2022

(54) Bookshelf Saferoom

(71) Applicant: Daniel Patrick O'Toole, Corona, CA (US)

(72) Inventor: Daniel Patrick O'Toole, Corona, CA (US)

(21) Appl. No.: 17/727,591

(22) Filed: Apr. 22, 2022

Related U.S. Application Data
(63) Continuation-in-part of application No. 29/780,019, filed on Apr. 22, 2021.
(60) Provisional application No. 63/179,754, filed on Apr. 26, 2021.

(51) Int. Cl. E04H 9/14; A47B 63/00; E05G 1/024

(52) U.S. Cl. CPC E04H 9/14; A47B 63/00; E05G 1/024

(57) ABSTRACT

A bookshelf saferoom includes a rectangular frame structure, a front panel, a rear panel, a lateral panel, a door panel, a top panel, a bottom panel, at least one locking assembly, and a plurality of shelves. The rectangular frame structure is perimetrically enclosed by the front panel, the rear panel, the lateral panel, the top panel, and the bottom panel to configure an enclosure. The entrance opening is delineated by the front panel, the rear panel, the lateral panel, the top panel, and the bottom panel thus allowing the door panel to be hingedly mounted to the rectangular frame structure. The least one locking assembly is integrated between the rectangular frame structure and the door panel to secure the door panel externally or internally. The plurality of shelves is externally mounted to the front panel so that the enclosure can be inconspicuous to the intruders.

The current application claims a priority to the U.S. Provisional Patent application Ser. No. 63/179,754 filed on Apr. 26, 2021.

### FIELD OF THE INVENTION

The present invention relates to a saferoom that stores valuable items or protect an individual in an emergency situation. More specifically, the present invention is a discreet saferoom that is disguised as a bookshelf.

### BACKGROUND OF THE INVENTION

When it comes to an unpredictable emergency, it is important to have an emergency exit plan or a safety device that ensures an individual's safety against the emergency. Throughout society, violence has always existed due to the uncertainty and unpredictability of human behavior. One situation that occurs on rare occasion is an intruder of any sort of property. In addition, an intruder may be armed with some sort of weapon for them to achieve their primary goal. When an intruder appears, it is an often occurrence that the victim of an intruder may hide in a discreet location away from the intruder to ensure safety. An issue of hiding away from an intruder is the availability of location or area in which the victim is guaranteed to be safe.

An objective of the present invention is to provide a structure that is used as a saferoom. The present invention provides a saferoom that is disguised as a bookshelf. The present invention further provides at least one opening so that the user can safely stay within the saferoom and inspects surrounding area. Furthermore, the present invention provides a detachable wall that can only be removed from the inside of the saferoom for emergency uses.

### BRIEF DESCRIPTION OF THE DRAWINGS

FIG. 1 is a top perspective view of the present invention, showing the closed configuration.

FIG. 2 is a top perspective view of the present invention, showing the opened configuration.

FIG. 3 is a side view of the present invention, showing the door panel.

FIG. 4 is a side view of the present invention, showing the lateral panel.

FIG. 5 is a rear view of the present invention.

FIG. 6 is a top view of the present invention, wherein the dash lines illustrate the door panel positioning within the closed configuration.

FIG. 7 is a top view of the present invention, wherein the dash lines illustrate the door panel positioning within the opened configuration.

FIG. 8 is an exploded view of the present invention, showing the removable positioning of the front panel.

### DETAIL DESCRIPTIONS OF THE INVENTION

All illustrations of the drawings are for the purpose of describing selected versions of the present invention and are not intended to limit the scope of the present invention.

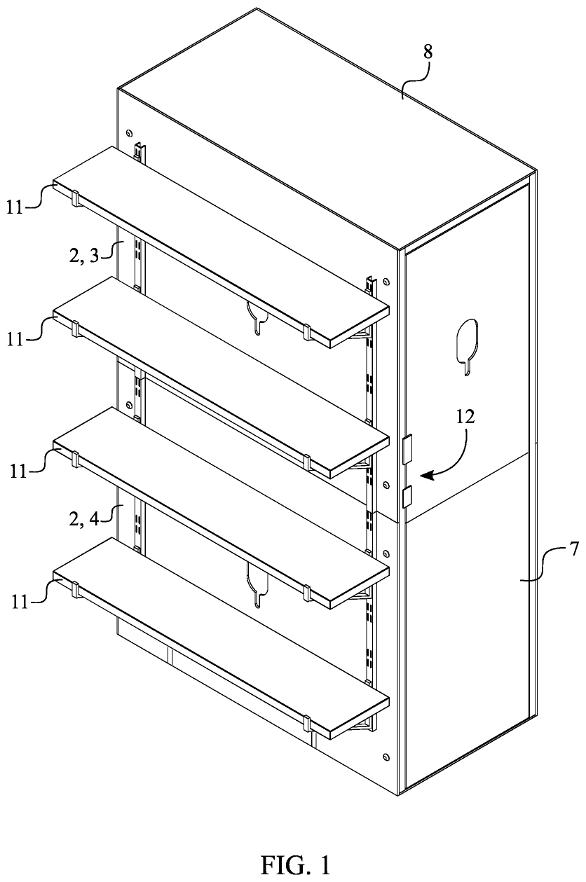

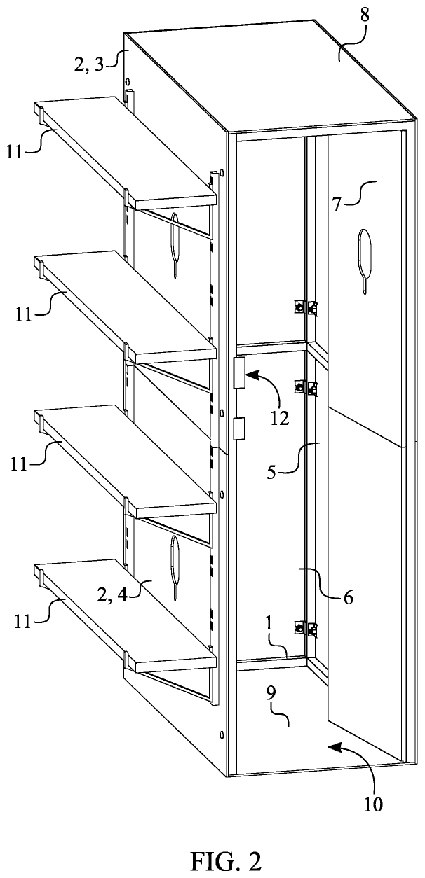

The present invention is a bookshelf saferoom that functions as a saferoom. The present invention is disguised as a bookshelf so that the user can safely stay inside and inspects the surrounding area or store valuable items within. As shown in FIG. 1-2, the present invention comprises a rectangular frame structure 1, a front panel 2, a rear panel 5, a lateral panel 6, a door panel 7, a top panel 8, a bottom panel 9, an entrance opening 10, at least one locking assembly 12, and a plurality of shelves 11.

In reference to the general configuration of the present invention, as shown in FIG. 1-2, the rectangular frame structure 1 functions as the structural body of the present invention thus determining the physical shape. The rectangular frame structure 1 is perimetrically enclosed by the front panel 2, the rear panel 5, the lateral panel 6, the top panel 8, and the bottom panel 9 to complete an enclosure that is opened from one side. In other words, the entrance opening 10 is delineated by the front panel 2, the rear panel 5, the lateral panel 6, the top panel 8, and the bottom panel 9 so that the user can access the interior space of the enclosure. The door panel 7 is hingedly mounted to the rectangular frame structure 1 about the entrance opening 10 to provide or restrict access into the interior space of the enclosure. The at least one locking assembly 12 is integrated between the rectangular frame structure 1 and the door panel 7, wherein the at least locking assembly selectively locks or unlock the door panel 7 to the enclosure. The plurality of shelves 11 is externally mounted to the front panel 2 to disguise the present invention as a bookshelf.

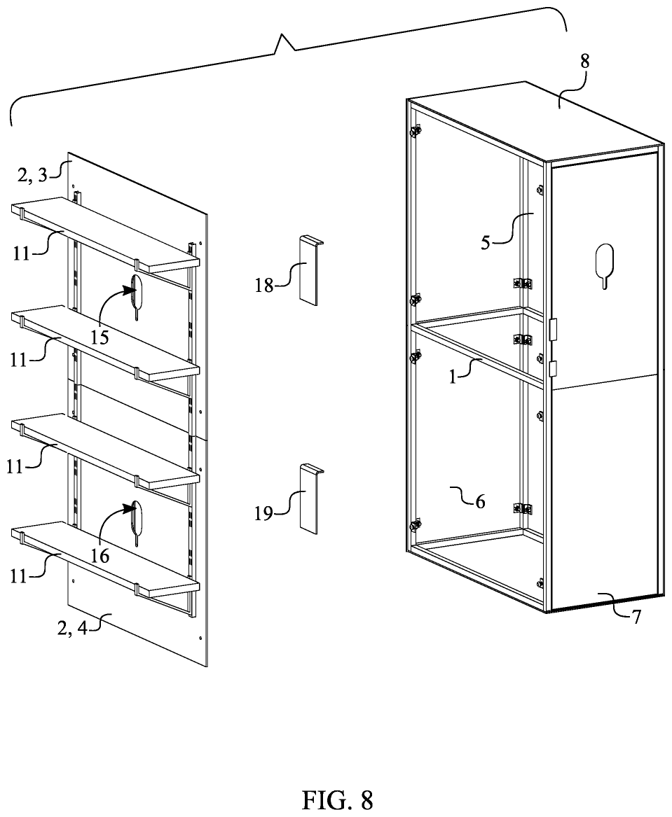

In reference to FIGS. 2 and 8, the rectangular frame structure 1 is a rigid structure that surround by the front panel 2, the rear panel 5, the lateral panel 6, the top panel 8, and the bottom panel 9. The rectangular frame structure 1 can be described as a skeletal structure that shapes the overall physical structure of the present invention.

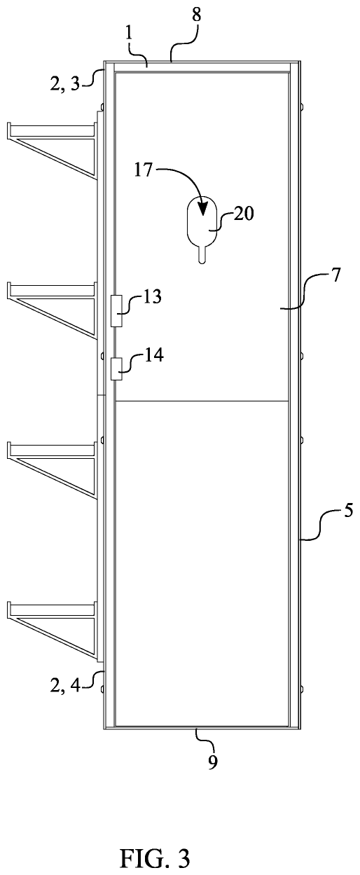

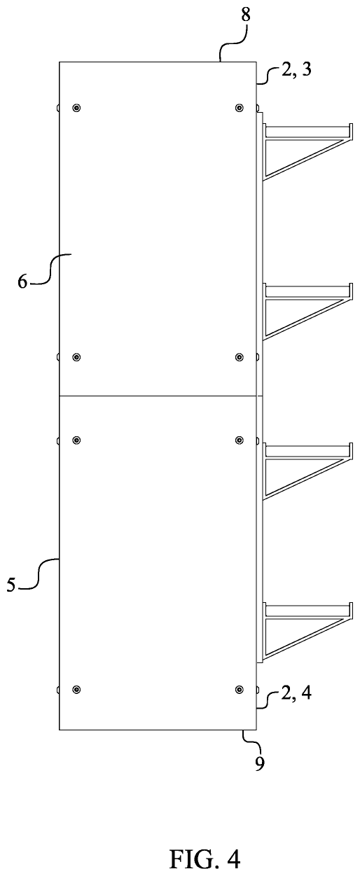

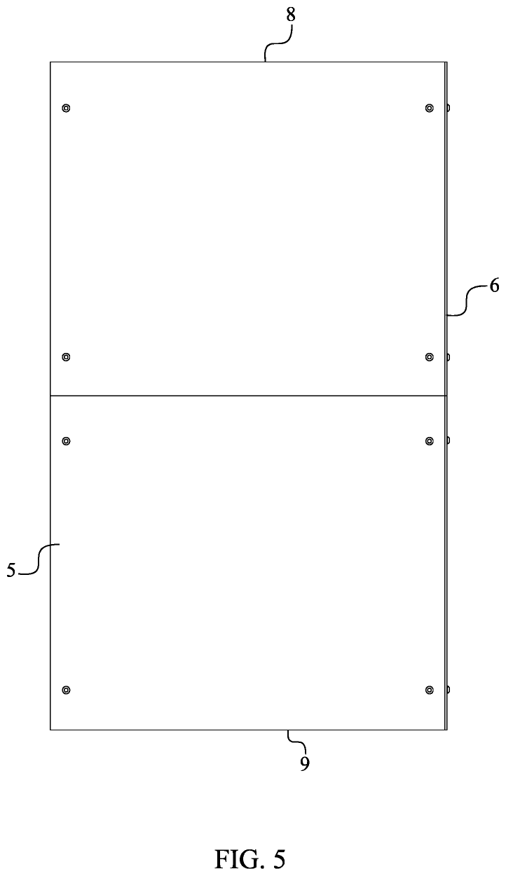

The front panel 2, the rear panel 5, the lateral panel 6, the top panel 8, and the bottom panel 9 are flat panel-like structures that are utilized as barrier for the interior space of the enclosure. In addition, the front panel 2, the rear panel 5, the lateral panel 6, the top panel 8, and the bottom panel 9 are protective surfaces that encloses the rectangular frame structure 1 while delineating the entrance opening 10. The front panel 2, the rear panel 5, the lateral panel 6, the top panel 8, and the bottom panel 9 are made out of sturdy material that can withstand bullets from firearms such as a thick slab of steel. In reference to FIG. 3-5, the front panel 2 and the rear panel 5 are oppositely positioned of each other about the rectangular frame structure 1 and positioned parallel to each other. The front panel 2 is perimetrically mounted onto the rectangular frame structure 1 thus covering the front side of the rectangular frame structure 1. The rear panel 5 is perimetrically connected onto the rectangular frame structure 1 thus covering the rear side of the rectangular frame structure 1. The top panel 8 and the bottom panel 9 are oppositely positioned of each other about the rectangular frame structure 1. The top panel 8 is perimetrically connected onto the rectangular frame structure 1 and covers the top side of the rectangular frame structure 1. More specifically, the top panel 8 is positioned in between the front panel 2 and the rear panel 5 and perpendicularly positioned to the front panel 2 and the rear panel 5. The bottom panel 9 is perimetrically connected onto the rectangular frame structure 1 covers the bottom side of the rectangular frame structure 1. More specifically, the bottom panel 9 is positioned in between the front panel 2 and the rear panel 5 and perpendicularly positioned to the front panel 2 and the rear panel 5. The lateral panel 6 is perimetrically connected onto the rectangular frame structure 1, wherein the lateral panel 6 is perpendicularly positioned to the top panel 8, the bottom panel 9, the front panel 2, and the rear panel 5.

In reference to FIG. 1-2, the front panel 2 comprises a top section 3 and a bottom section 4 that separate the front panel 2 into two separate panels. More specifically, the top section 3 is positioned adjacent to the top panel 8 and removably mounted to the rectangular frame structure 1 from the interior space of the enclosure. Similarly, the bottom section 4 is positioned adjacent to the bottom panel 9 and removably mounted to the rectangular frame structure 1 from the interior space of the enclosure. As a result, the user is able to remove the top section 3 and/or the bottom section 4 from the interior space of the enclosure when necessary. For example, when the door panel 7 is blocked from outside, the user can create an exit opening through the removal of the top section 3 or the bottom section 4 from the interior space of the enclosure.

The door panel 7 is a revolving barrier at the entrance opening 10 to the interior space of the enclosure. In reference to FIG. 1-2, the door panel 7 is mounted to the rectangular frame structure 1 from the inside and operates similarly to a standard door. In other words, the door panel 7 angularly rotates about the rear panel 5 to delineate an opened configuration and a closed configuration for the present invention. Furthermore, the door panel 7 rotates towards the interior space of the enclosure to ensure that the door panel 7 is not blocked from outside.

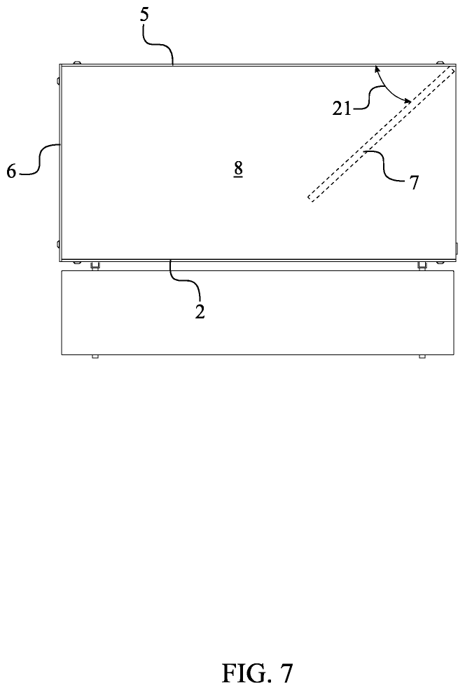

In reference to FIG. 2 and FIG. 7, when the present invention is at the opened configuration, the door panel 7 and the rear panel 5 are positioned at an acute angle 21. In other words, the door panel 7 is positioned within the front panel 2, the rear panel 5, the top panel 8, and the bottom panel 9 so that the user can access the entrance opening 10.

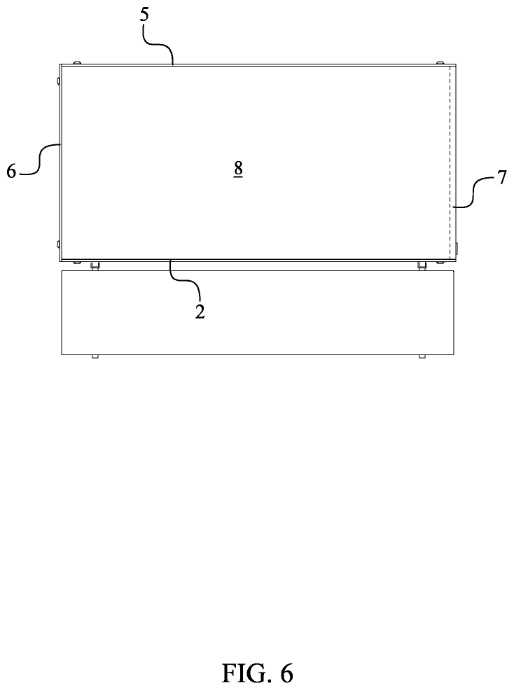

In reference to FIG. 1 and FIG. 6, when the present invention is at the closed configuration, the door panel 7 is perpendicularly positioned to the rear panel 5. The door panel 7 and the rear panel 5 are positioned at a right angle. In other words, the door panel 7 and the lateral panel 6 are positioned parallel to each other so that the entrance opening 10 can be completely blocked.

In reference to FIG. 1-3, the at least one locking assembly 12 comprises a first lock 13 that is externally integrated in between the door panel 7 and the rectangular frame structure 1. More specifically, the first lock 13 allows the user to store valuable items within the present invention as the first lock 13 is secured from the outside. Preferably, the first lock 13 is a deadbolt lock to enhance the strength and security of the present invention.

In reference to FIG. 1-3, the at least one locking assembly 12 comprises a second lock 14 that is internally integrated in between the door panel 7 and the rectangular frame structure 1. More specifically, the second lock 14 allows the user to lock themselves within the present invention as the second lock 14 is secured from the interior space of the enclosure. Preferably, the second lock 14 is a deadbolt lock to enhance the strength and security of the present invention.

In reference to FIG. 8, the present invention further comprises a top access opening 15 and a top cover plate 18. The top access opening 15 traverses through the top section 3 of the front panel 2 and shaped into a keyhole. More specifically, the top access opening 15 is centered on the top section 3 and is utilized as a peeking hole from the interior space of the enclosure. The top cover plate 18 is slidably engaged with the top section 3 and internally positioned adjacent to the top access opening 15 so that the user can easily cover or uncover the top access opening 15 when necessary. The top cover plate 18 prevents entry to the top access opening 15 at its natural state and cannot be tampered from the outside of the enclosure. For example, when the user needs to peek outside, the user can easily slide up the top cover plate 18 to open the top access opening 15.

In reference to FIG. 8, the present invention further comprises a bottom access opening 16 and a bottom cover plate 19. The bottom access opening 16 traverses through the bottom section 4 of the front panel 2 and shaped into a keyhole. More specifically, the bottom access opening 16 is centered on the bottom section 4 and is utilized as a peeking hole from the interior space of the enclosure. The bottom cover plate 19 is slidably engaged with the bottom section 4 and internally positioned adjacent to the bottom access opening 16 so that the user can easily cover or uncover the bottom access opening 16 when necessary. The bottom cover plate 19 prevents entry to the top access opening 15 at its natural state and cannot be tampered from the outside of the enclosure. For example, when the user needs to peek outside, the user can easily slide up the bottom cover plate 19 to open the bottom access opening 16.

In reference to FIG. 3, the present invention further comprises a door access opening 17 and a door cover plate 20. The door access opening 17 traverses through the door panel 7 and shaped into a keyhole. More specifically, the door access opening 17 is utilized as a peeking hole from the interior space of the enclosure. The door cover plate 20 is slidably engaged with the door panel 7 and internally positioned adjacent to the door access opening 17 so that the user can easily cover or uncover the door access opening 17 when necessary. The door cover plate 20 prevents entry to the door access opening 17 at its natural state and cannot be tampered from the outside of the enclosure. For example, when the user needs to peek outside, the user can easily slide up the door cover plate 20 to open the door access opening 17.

The top access opening 15, the bottom access opening 16, and the door access opening 17 are big enough to allow small objects to be moved through the keyhole slots. In addition, the keyhole shape and size provide a unique function to allow users from within the present invention to draw weapons such as a firearm to neutralize potential threat on the exterior side of the present invention. The top access opening 15, the bottom access opening 16, and the door access opening 17 each comprises a top segment and a bottom segment. More specifically, the top segment is oriented toward the top panel 8 and the bottom segment is oriented toward the bottom panel 9. A width of the top segment is larger than A width of the bottom segment. A height of the top segment is larger than A height of the bottom segment. As a result, the user can first access the bottom segment and then the top segment when the corresponding cover plate is moved upwardly. The bottom segment is preferably utilized to peek outside as the intruders are not able to aim or insert a weapon through the bottom segment that is narrower and smaller. The top segment is preferably utilized to draw weapons from the interior space of the enclosure through the top segment that is wider and larger.

The top cover plate 18, the bottom cover plate 19, and the door cover plate 20 are made out of sturdy material that are able to withstand bullets from firearms. Preferably, the top cover plate 18, the bottom cover plate 19, and the door cover plate 20 are made out of bulletproof material such as a thick slab of steel.

In reference to FIG. 1-9, each of the plurality of shelves 11 is a platform that is mounted to the exterior side of the top section 3 and the bottom section 4. The plurality of shelves 11 can be utilized as a storage space or an area to display objects. More specifically the plurality of shelves 11 is primarily mounted on the front panel 2 and functions as a mechanism to disguise the saferoom from the plain sight of an intruder.

To use the present invention, the user unlocks and open the door panel 7 through the first lock 13. Once the door panel 7 is opened and the present invention at the opened configuration, the user can enter into the interior space of the enclosure and close the door panel 7. Once the present invention is at the closed configuration, the second lock 14 can be utilized to lock and secure the door panel 7 from the interior space of the enclosure. Once the door panel 7 is locked, the user is able to stay inside the present invention as long as desired. The user can further utilize the top access opening 15, the bottom access opening 16, and the door access opening 17 to peek outside or to defend themselves from an intruder. In case of emergency, the user is able to remove the top section 3 and/or the bottom section 4 as an alternative means of exit/escape from within the present invention. More specifically, the user is able to remove the top section 3 and/or the bottom section 4 from the rectangular frame structure 1 which allow an alternative opening to exit the present invention when the door panel 7 is unable to be used.

Although the invention has been explained in relation to its preferred embodiment, it is to be understood that many other possible modifications and variations can be made without departing from the spirit and scope of the invention as hereinafter claimed.

What is claimed is:

1. A bookshelf saferoom comprising:
a rectangular frame structure;
a front panel;
a rear panel;
a lateral panel;
a door panel;
a top panel;
a bottom panel;
an entrance opening;
at least one locking assembly;
a plurality of shelves;
the rectangular frame structure being perimetrically enclosed by the front panel, the rear panel, the lateral panel, the top panel, and the bottom panel;
the entrance opening being delineated by the front panel, the rear panel, the lateral panel, the top panel, and the bottom panel;
the door panel being hingedly mounted to the rectangular frame structure about the entrance opening;
the at least one locking assembly being integrated between the rectangular frame structure and the door panel; and
the plurality of shelves being externally mounted to the front panel.

2. The bookshelf saferoom as claimed in claim 1 comprising:
the front panel and the rear panel being oppositely positioned of each other about the rectangular frame structure;
the front panel and the rear panel being positioned parallel to each other;
the front panel being perimetrically mounted onto the rectangular frame structure;
the rear panel being perimetrically connected onto the rectangular frame structure;
the top panel and the bottom panel being oppositely positioned of each other about the rectangular frame structure;
the top panel being perimetrically connected onto the rectangular frame structure;
the top panel being positioned in between the front panel and the rear panel;
the top panel being perpendicularly positioned to the front panel and the rear panel;
the bottom panel being perimetrically connected onto the rectangular frame structure;
the bottom panel being positioned in between the front panel and the rear panel;
the bottom panel being perpendicularly positioned to the front panel and the rear panel;
the lateral panel being perimetrically connected onto the rectangular frame structure; and
the lateral panel being perpendicularly positioned to the top panel, the bottom panel, the front panel, and the rear panel.

3. The bookshelf saferoom as claimed in claim 1 comprising:
the front panel comprising a top section and a bottom section;
the top section being positioned adjacent to the top panel;
the top section being removably mounted to the rectangular frame structure;
the bottom section being positioned adjacent to the bottom panel; and
the bottom section being removably mounted to the rectangular frame structure.

4. The bookshelf saferoom as claimed in claim 1, wherein the door panel angularly rotates about the rear panel to delineate an opened configuration and a closed configuration.

5. The bookshelf saferoom as claimed in claim 4 comprising:
the opened configuration;
the door panel and the rear panel being positioned at an acute angle; and
the door panel being positioned within the front panel, the rear panel, the top panel, and the bottom panel.

6. The bookshelf saferoom as claimed in claim 4 comprising:
the closed configuration;
the door panel being perpendicularly positioned to the rear panel; and
the door panel and the lateral panel being positioned parallel to each other.

7. The bookshelf saferoom as claimed in claim 1 comprising:
the at least one locking assembly comprising a first lock; and
the first lock being externally integrated in between the door panel and the rectangular frame structure.

8. The bookshelf saferoom as claimed in claim 1 comprising:
the at least one locking assembly comprising a second lock; and
the second lock being internally integrated in between the door panel and the rectangular frame structure.

9. The bookshelf saferoom as claimed in claim 1 comprising:
atop access opening;
a top cover plate;
the top access opening traversing through a top section of the front panel;
the top cover plate being slidably engaged with the top section; and
the top cover plate being internally positioned adjacent to the top access opening.

10. The bookshelf saferoom as claimed in claim 1 comprising:
a bottom access opening;
a bottom cover plate;
the bottom access opening traversing through a bottom section of the front panel;
the bottom cover plate being slidably engaged with the bottom section; and
the bottom cover plate being internally positioned adjacent to the bottom access opening.

11. The bookshelf saferoom as claimed in claim 1 comprising:
a door access opening;
a door cover plate;
the door access opening traversing through the door panel;
the door cover plate being slidably engaged with the door panel; and
the door cover plate being internally positioned adjacent to the door access opening.

12. A bookshelf saferoom comprising:
a rectangular frame structure;
a front panel;
a rear panel;
a lateral panel;
a door panel;
a top panel;
a bottom panel;
an entrance opening;
at least one locking assembly;
a plurality of shelves;
a door access opening;
a door cover plate;
the rectangular frame structure being perimetrically enclosed by the front panel, the rear panel, the lateral panel, the top panel, and the bottom panel;
the entrance opening being delineated by the front panel, the rear panel, the lateral panel, the top panel, and the bottom panel;
the door panel being hingedly mounted to the rectangular frame structure about the entrance opening;
the at least one locking assembly being integrated between the rectangular frame structure and the door panel;
the plurality of shelves being externally mounted to the front panel;
the door access opening traversing through the door panel;
the door cover plate being slidably engaged with the door panel; and
the door cover plate being internally positioned adjacent to the door access opening.

13. The bookshelf saferoom as claimed in claim 12 comprising:
the front panel and the rear panel being oppositely positioned of each other about the rectangular frame structure;
the front panel and the rear panel being positioned parallel to each other;
the front panel being perimetrically mounted onto the rectangular frame structure;
the rear panel being perimetrically connected onto the rectangular frame structure;
the top panel and the bottom panel being oppositely positioned of each other about the rectangular frame structure;
the top panel being perimetrically connected onto the rectangular frame structure;
the top panel being positioned in between the front panel and the rear panel;
the top panel being perpendicularly positioned to the front panel and the rear panel;
the bottom panel being perimetrically connected onto the rectangular frame structure;
the bottom panel being positioned in between the front panel and the rear panel;
the bottom panel being perpendicularly positioned to the front panel and the rear panel;
the lateral panel being perimetrically connected onto the rectangular frame structure; and
the lateral panel being perpendicularly positioned to the top panel, the bottom panel, the front panel, and the rear panel.

14. The bookshelf saferoom as claimed in claim 12 comprising:
the front panel comprising a top section and a bottom section;
the top section being positioned adjacent to the top panel;
the top section being removably mounted to the rectangular frame structure;
the bottom section being positioned adjacent to the bottom panel; and
the bottom section being removably mounted to the rectangular frame structure.

15. The bookshelf saferoom as claimed in claim 12, wherein the door panel angularly rotates about the rear panel to delineate an opened configuration and a closed configuration.

16. The bookshelf saferoom as claimed in claim 15 comprising:
the opened configuration;
the door panel and the rear panel being positioned at an acute angle; and
the door panel being positioned within the front panel, the rear panel, the top panel, and the bottom panel.

17. The bookshelf saferoom as claimed in claim 15 comprising:
the closed configuration;
the door panel being perpendicularly positioned to the rear panel; and
the door panel and the lateral panel being positioned parallel to each other.

18. The bookshelf saferoom as claimed in claim 12 comprising:
the at least one locking assembly comprising a first lock; and
the first lock being externally integrated in between the door panel and the rectangular frame structure.

19. The bookshelf saferoom as claimed in claim 12 comprising:
the at least one locking assembly comprising a second lock; and
the second lock being internally integrated in between the door panel and the rectangular frame structure.

20. The bookshelf saferoom as claimed in claim 12 comprising:
atop access opening;
a top cover plate;
a bottom access opening;
a bottom cover plate;
the top access opening traversing through a top section of the front panel;
the top cover plate being slidably engaged with the top section; and
the top cover plate being internally positioned adjacent to the top access opening.
the bottom access opening traversing through a bottom section of the front panel;
the bottom cover plate being slidably engaged with the bottom section; and
the bottom cover plate being internally positioned adjacent to the bottom access opening.
